(19) United States
(12) Patent Application Publication
(10) Pub. No.: US 2015/0219329 A1
(43) Pub. Date: Aug. 6, 2015

(54) LED LIGHTING

(71) Applicants: Hyun Jik Kim, Gyeonggi-do (KR); DAEDONG CO., LTD., Busan (KR); ECOBI CO. LTD, Gyeonggi-do (KR)

(72) Inventor: Hyun Jik Kim, Seongnam-si (KR)

(21) Appl. No.: 14/361,474

(22) PCT Filed: Jan. 31, 2012
(86) PCT No.: PCT/KR2012/000733

§ 371 Date: Oct. 29, 2014

(30) Foreign Application Priority Data
Nov. 29, 2011 (KR) 10-2011-0126072

(51) Int. Cl. F21V 29/51; F21V 29/503; F21K 99/00; F21V 15/01

(52) U.S. Cl. CPC F21V 29/51; F21V 15/01; F21V 29/503; F21K 9/00

(57) ABSTRACT

There is provided an LED lighting having a modularized heat dissipating structure capable of effectively dissipating heat generated by an LED device upon turning on the light. The LED lighting comprises: a heat pipe module including a heat pipe and a heat pipe holder installed on the top of an LED module; a lower case positioned below the heat pipe module and the LED module, to receive the heat pipe module and the LED module; and an upper case connected with the lower case, to define an inner space to receive the heat pipe module and the LED module, wherein molding is inserted between the upper case and the lower case to be connected with each other. Preferably, the heat pipe module comprises: the heat pipe holder installed on the top of the LED module; and the heat pipe attached around the heat pipe holder. The heat pipe holder has a plane shape of “+” or “−” and comprises: an upper heat pipe holder and a lower heat pipe holder, each end of the upper heat pipe holder and each end of the lower heat pipe end are bent so that the each end of the upper heat pipe holder touches the each corresponding ends of the lower heat pipe holder. Sots in the shape of “+” or “−” are respectively formed with a predetermined width at the center areas on the top side of the upper heat pipe holder and the center areas on the underside of the lower heat pipe holder, to receive the heat pipe.

### TECHNICAL FIELD

The present invention relates to an LED lighting having an LED device as a light source, and more particularly, to an LED lighting which has a modularized heat dissipating structure to effectively dissipate heat generated by an LED device upon lighting.

### BACKGROUND ART

Generally, lighting is installed, at regular distance, at the sides of an express way, major roads in a section of a city, roads in a commercial area, the sides of a road in a residential area or bridge, etc., to light the way for safe passage of a vehicle or pedestrian. Lighting is also used to light a dark room. That is, lighting secures the safety of a driver, pedestrian and indoor person at night or when a surrounding area is darkened by hick fog, etc., by converting electric energy to light energy to provide light to identify an object outdoors or indoors. Previously, an incandescent lamp, fluorescent lamp, high pressure mercury lamp and sodium vapor lamp have been used as the light source of lighting.

However, an incandescent lamp is inexpensive while has a short life, low luminous efficiency and high brightness causing glare and generates a lot of heat. A fluorescent lamp has low power consumption because it has a high energy efficiency compared with an incandescent lamp. However, its lighting waiting time is long and its life is short. In addition, a sodium vapor lamp and a high pressure mercury lamp have high power consumption and these may cause glare. Life of these lamps is not long.

Due to the aforementioned problems, a light has been developed by using an LED (lighting emitting diode) which has a semi-permanent life, low power consumption and high efficient intensity of illumination. This light has been widely used for a diversity of usages.

LED has the merits of high-efficient illumination intensity and low power consumption. It is also eco-friendly and has high energy efficiency. Therefore, the use of LED has gradually increased and governments also positively recommend it. Additionally, when a light using an LED is used, power is reduced by 60%˜80% compared with the other traditional lights. Since an LED has a semi-permanent life of more than 50,000 hours and does not cause glare, it is receiving a lot of attention as a light.

However, the LED lighting has high heat generation rate since a number of LEDs are mounted on a print circuit board. Therefore, if heat generated in the inside is not smoothly dissipated or removed when turning on the light, the efficiency decreases and the life is shortened upon continuous use for a long time.

As one of the existing techniques to solve this problem is a method of releasing heat generating in LED by using radiation ribs formed in a housing is disclosed in Korean Utility Model Laid-Open Publication No. 2011-0002984 entitled “LED lighting”. This conventional art is briefly described referring to FIG. 1. When a power supply is applied to a housing 2 with radiation ribs 3, an LED light source 1 inside a cover 5 is turned on and the LED light source 1 emits light and is gradually heated. Then, the heat generated in the whole LED light source 1 is dissipated to the outside through the radiation ribs 3 and radiation channels 4 formed under the radiation rib 3.

However, in the LED lighting, the heat generated from the LED light source is conducted to the radiation ribs and the radiation channels, so that it is heat-exchanged with the air of the outside. Since the heat generated from the LED light source is cooled in this manner, maintenance and repair costs are reduced. However, since the radiation ribs and the radiation channels are structured and positioned to be exposed to the outside, there is a problem in achieving the optimum cooling efficiency due to any damage or attachment of foreign materials. Moreover, since the housing is manufactured by extruding aluminum, post-processes are performed after the extruding and therefor the ultimate cost of the product increases.

### DISCLOSURE

### Technical Problem

Therefore, it is an object of the present invention to solve the above problems and to provide an LED lighting having a modularized heat dissipating structure to improve the efficiency of illumination and prolong the lifespan by smoothly and quickly dissipating heat generated in an LED module when turning on the light, to reduce installation and maintenance/repair costs by using no other mechanical cooling elements, and to realize the optimum cooling efficiency by more efficiently dissipating the heat.

In accordance with an aspect of the present invention, there is provided an LED lighting comprising: a heat pipe module including a heat pipe and a heat pipe holder installed on the top of an LED module; a lower case positioned under the heat pipe module and the LED module, to receive the heat pipe module and the LED module; and an upper case connected with the lower case, to define an inner space to the heat pipe module and the LED module. Molding is inserted between the upper case and the lower case, to connect the upper case and the lower case.

Preferably, the heat pipe module comprises: the heat pipe holder installed on the top of the LED module; and the heat pipe holder attached around the heat pipe holder. The heat pipe holder has a plane shape of “+” or “−” and comprises an upper heat pipe holder and a lower heat pipe holder, each end of the upper heat pipe holder and each end of the lower heat pipe holder being bent so that the each end of the upper heat pipe holder touches the each corresponding end of the lower heat pipe holder. The upper heat pipe holder and the lower heat pipe holder respectively include slots formed with a predetermined width at the center areas on the top side of the upper heat pipe holder and the center area on the underside of the lower heat pipe holder. The heat pipe is fitted into the slots. The upper heat pipe holder includes an insertion groove formed at the each end thereof and the lower heat pipe holder includes a projection formed at the each end thereof, so that the each projection is fitted into the each insertion groove, to connect the upper heat pipe holder and the lower heat pipe holder.

Preferably, spaces between top side of the heat pipe module and the upper case, and between underside of the heat pipe module and the lower case are filled thermal grease or metal solder. The lower case further comprises: an opening formed in the center of the lower case, to permit the light of the LED device to shine to the outside; and a plurality of drain holes formed at regular intervals, along with the edge of the lower case, to allow rainwater to flow out. The LED lighting may comprise a plurality of the heat pipe modules and a plurality of the LED modules installed in a case forming of the upper case and the lower case.

### Advantageous Effects

As described above, in the LED lighting according to the present invention, the heat generated in the LED module is thermally conducted through the heat pipe module having high heat conduction. The heat being conducted to the heat pipe is directly in contact with the case manufactured by an aluminum pressing method. Therefore, since the LED lighting comprises the heat dissipating system enabling the heat dissipation through the outside air and convection current through the case, it realizes the optimum efficiency of cooling and thus it prolongs the lifespan of the LED lighting. Further, since the LED lighting of the present invention does not use any other mechanical cooling element, such as a cooling fan, costs to install, maintain and/or repair the LED lighting are reduced. Additionally, since it is manufactured by the aluminum pressing method, the productivity is high and therefore it is possible to manufacture the LED lighting which is inexpensive in price and light in weight.

### DESCRIPTION OF DRAWINGS

These and other aspects and advantages of the present invention will become apparent and more readily appreciated from the following description of the embodiment(s), taken in conjunction with the accompanying drawings, in which:

FIG. 1 shows an LED lighting according to the conventional art;

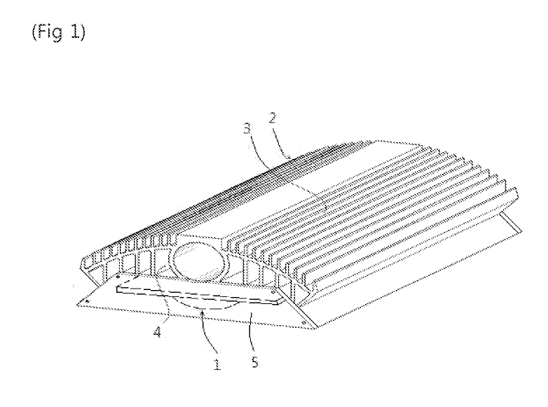

FIG. 2 is a perspective view of an LED lighting according to one embodiment of the present invention;

FIG. 3 is an exploded perspective view of the LED lighting (“+” shaped);

FIG. 4 is a perspective view of the LED lighting from which an upper case is removed;

FIG. 5 is a sectional view taken along a Line a-a′ in FIG. 3; and

FIG. 6 is an exploded perspective view of LED lighting according to the other embodiment of the present invention (“−” shaped);

### BEST MODE

The technical characteristics of the present invention will be specifically described with reference to the accompanying drawings.

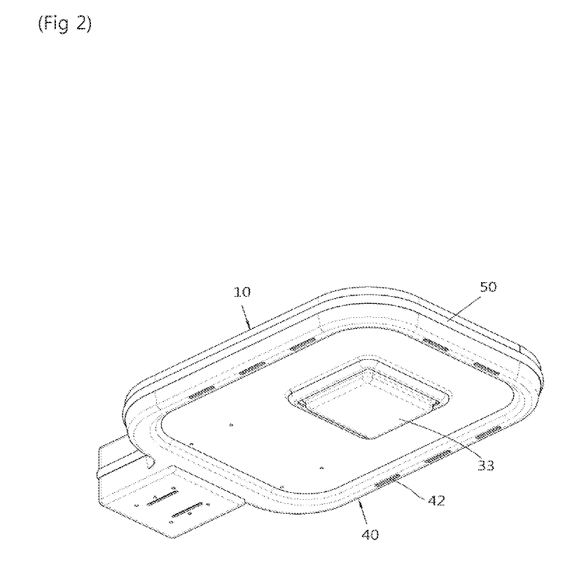

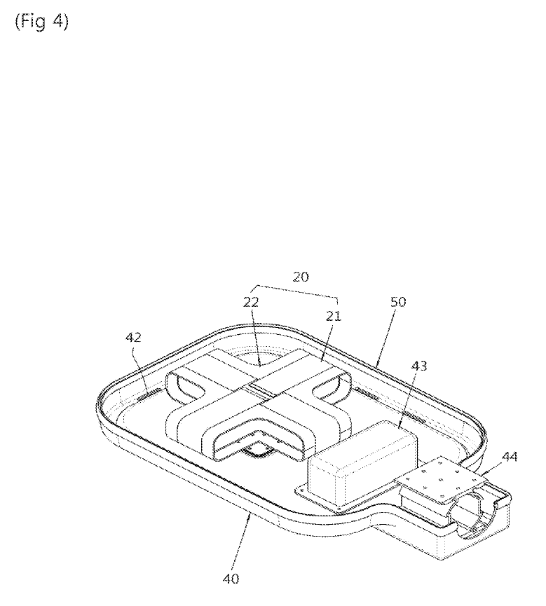

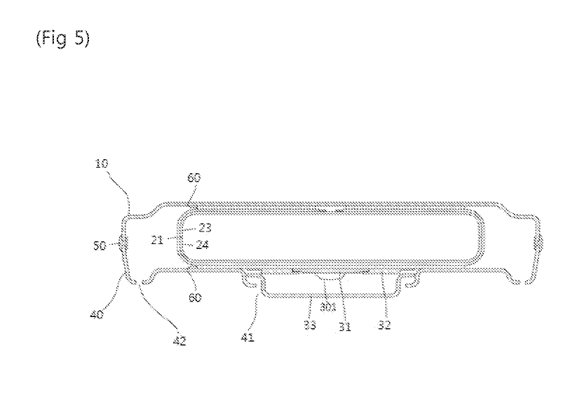

The present invention relates to an LED lighting having a modularized heat dissipating structure capable of effectively dissipating heat generated by an LED device. The LED lighting according to one embodiment of the present invention is described with reference to FIGS. 2 through 5.

In FIGS. 2 through 5, the LED lighting comprises: a heat pipe module 20 including a heat pipe 21 and a heat pipe holder 22, positioned on the top of an LED module 30; a lower case 40 positioned under the heat pipe module 20 and the LED module 30, to receive the heat pipe module 20 and the LED module 30; an upper case 10 connected with the lower case 40, to define an inner space to receive the heat pipe module 20 and the LED module 30.

Molding 50 is inserted between the upper case 10 and the lower case 40 forming a case. The upper case 10 and the lower case 40 are securely connected to each other by the molding 50, so that moisture or foreign materials are prevented from entering the case. It is possible to manufacture the molding 50 according to the shape of the case. Preferably, the molding 50 may use a rubber product with good elasticity or a plastic material.

A screw insertion hole (not shown in the relevant drawings) is formed in each corner of the lower case 40. A screw hole corresponding to the screw insertion hole is formed in the upper case 10. A screw is fastened to the screw insertion hole of the lower case 40 through the screw hole of the upper case 10, so that the upper case 10 and the lower case 40 are firmly connected.

The LED module 30 comprises a PCB 31 attached to the underside of the heat pipe module(20); an LED device 301 evenly arranged in the PCB 31; and a board cover 32 including an opening formed in its center, positioned under the PCB 31. The PCB 31 may be a synthetic resin board or a metal board in which the heat transfer efficiency is excellent. The board cover 32 is structured so that the PCB 31 is stably attached to the heat pipe module 20. The LED device 301 downwardly protrudes through the opening (not marked with a drawing reference number in the drawing) formed in the center of the board cover 32, so that light shines to the outside through a lens 33 and an opening 41 of the lower case 40. The LED module 30 and the heat pipe module 20 are connected to each other by the fastening of the screws, thereby forming a single engine module. Thermal grease 60 or metal solder is filled between the LED module 30 and the heat pipe module 20.

The heat pipe module 20 received in the lower case 40 comprises the heat pipe holder 22 installed on the top of the LED module 30 and the heat pipe 21 attached around the heat pipe holder 22. The thermal grease 60 or metal solder which is a thermal conductive material fills the space between the LED module 30 and the heat pipe module 20, to remove any fine separation distance between the LED module 30 and the heat pipe module 20 and therefore to efficiently transfer to the heat pipe module 20 the heat generated by the LED module 30 when turning on the light. That is, the thermal conductivity is improved by replacing an air layer between the heat pipe module 20 and the LED module 30 with the thermal conductive material, thermal grease 60 or metal solder. The heat pipe module 20 may be manufactured by injecting, extruding or die-casting and it is made by using aluminum or copper having an excellent thermal conduction quality. In the present invention, the heat pipe module 20 is preferably manufactured by pressing aluminum which is easily available for mass productivity and inexpensive.

The heat pipe holder 22 comprises an upper heat pipe holder 23 and a lower heat pipe holder 24. The upper and lower heat pipe holders have a plane shape of “+” or “−”. Each end of the upper and lower heat pipe holders in the “+” or “−” shape is bent so that the each end of the upper heat pipe holder touches the each corresponding end of the lower heat pipe holder. That is, the each end of the upper heat pipe holder 23 is bent downwardly and the each end of the lower heat pipe holder 24 is bent upwardly, so that the corresponding ends of the upper and lower heat pipe holders 23, 24 touch each other.

An insertion groove 231 is formed at the each end of the upper heat pipe holder 23 and a projection 241 is formed at the each end of the lower heat pipe holder 24. Each of the projections 241 is fitted into each of the insertion grooves 231 so that the upper heat pipe holder 23 is connected with the lower heat pipe holder 24 to constitute the single heat pipe holder 22.

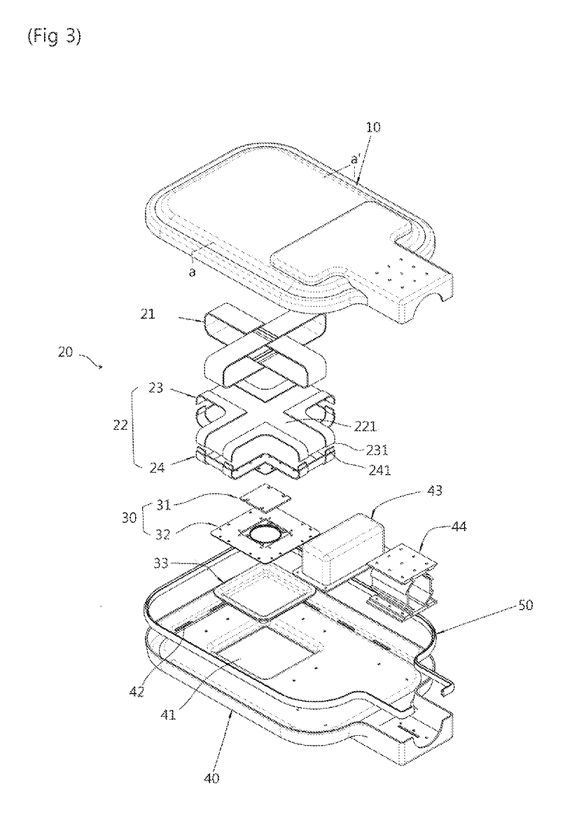

The heat pipe module 20 is completed by connecting the heat pipe 21 with the heat pipe holder 22. Slots 221 in the plane shape of “+” or “−” are respectively formed with a predetermined width at the center area on the top side of the upper heat pipe holder 23 and the center area on the underside of the lower heat pipe holder 24 as shown in FIG. 3. The heat pipe 21 is fitted into the slots 221, to constitute the heat pipe module 20 having the heat dissipating function. A refrigerant (working fluid) is filled in the heat pipe 21 and the refrigerant transfer heat between the both ends of the heat pipe 21 through the phase change processes of evaporation and liquefaction. Since the heat is moved by using latent heat, the heat pipe module 20 has a much greater heat transfer performance compared with general heat transferring apparatuses.

In the present invention, the heat generated by the LED module 30 is transferred to the case through heat pipe 21, to be dissipated. That is, the heat generated at the area where the LED module 30 is attached moves upwardly through the heat pipe 21 and is dissipated through the upper case 10 and some heat is conducted to the lower case 40 to be dissipated. Preferably, the case comprising the upper case 10 and lower case 40 is manufactured by the aluminum pressing method. The pressing method i proves the thermal conductivity compared with the die-casting or extruding method since, for example, the thermal conductivity is about 210 W/mk which is slightly higher than die-casting (about 96 W/mk) and extruding (about 150 W/mk). In addition, drain holes 42 are formed along with the edge of the lower case 40. When it rains, any rainwater entering the case through the connection components, such as screws, etc., is able to flow out to the outside, through the drain holes 42. In some cases, when connecting the upper case 10 and the lower case 40, a waterproof screw may be used and then the drain holes 42 may not be formed in the lower case 40.

The thermal grease which is a thermal conductive material is filled t the top side and underside of the heat pipe module 20 and between the upper and lower cases 10, 40, to better improve the thermal conductivity. The opening 41 is formed at the center of the lower case 40, to permit the light to shine to the outside. The lens 33 is fitted into the opening 41, to cover the opening 41, diffuse the light generated by the LED device 301 and to centralize the light in a predetermined direction. An SMPS (switching mode power supply) 43 to apply the power source to the LED module 30 is installed at one side in the lower case 40. A clamp 44 is installed at one end of the lower case 40 and connected to a support supporting the LED lighting.

The LED lighting according to the present invention comprises the heat dissipating system which is capable of thermally conducting the heat generated by the LED module 30 through the heat pipe module 20 having the high thermal conduction and which is capable of dissipating the heat conducted through the heat pipe 21 and directly in contact with the case including the upper case 10 and the lower case 40 manufactured by the aluminum pressing method through the outside air and convection current. Therefore, the LED lighting of the present invention performs efficient heat dissipation. Since this constitution does not need any other mechanical cooling elements, costs of maintaining and repairing the LED lighting are reduced and the efficiency of heat dissipation is more improved to prolong the lifespan of the LED module.

The product according to the present invention is manufactured by the aluminum pressing method. In this method, the weight is reduced by more than 40% compared with the aluminu die-casting method which is usually used previously. Additionally the cost of production is lowered utilizing mass production.

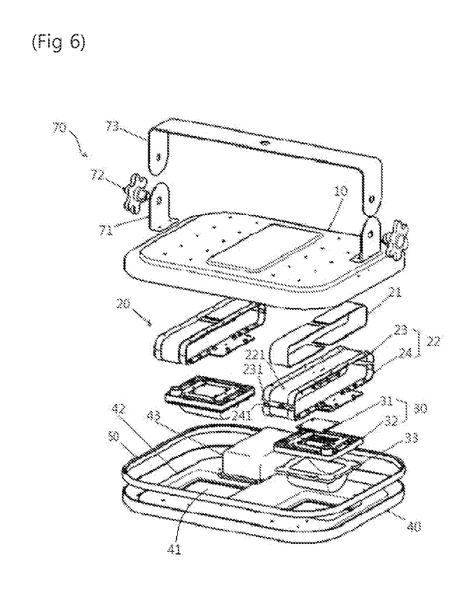

In FIG. 6, an LED lighting according to the other embodiment of the present invention comprises two engine modules, each engine module connecting a heat pipe module 20 and an LED module 30 and a case including an upper case 10 and a lower case 40 in which the two engine modules are installed. More than one engine module is installed in the case including the upper and lower cases 10, 40 by changing a design, to direct various lighting devices.

As shown in FIG. 6, the shape of a heat pipe module 20 is changed to “−”. Each end of an upper heat pipe holder 23 and each end of a lower heat pipe holder 24 are bent so that the each end of the upper heat pipe holder 23 touches the each corresponding end of the lower heat pipe holder 24. Slots 221 are respectively formed with a predetermined width at the center area on the top side of the upper heat pipe holder 23 and the center area on the underside of the lower heat pipe holder 24. The heat pipe 21 is received in the slots 221, to cons e a single heat pipe module 20. An LED module 30 including a PCB 31, an LED device 301 and a board cover 32 is attached under the heat pipe module 20, thereby constituting a single engine module.

An insertion groove 231 is formed at the each end of the upper heat pipe holder 23 and a projection 241 is formed at the each end of the lower heat pipe holder 24. The upper heat pipe holder 23 and the lower heat pipe holder 24 are connected with each other when the projections 241 are respectively fitted into the corresponding insertion groove 31, to constitute a single heat pipe holder 22. An opening 41 is formed in the center of the lower case 40, to allow the light of the LED device 301 to shine to the outside. A number of drain holes 42 are formed at regular intervals, along with the edge of the lower case 40, to allow rainwater to flow out. In this invention, two openings 41 are formed corresponding to the number of the engine modules. However, more than two openings 41 may be formed according to the number of the engine modules. Further, thermal grease or metal solder is filled in the spaces (contact surface) between top side of the heat pipe module (20) and the upper case(10), and between underside of the heat pipe module (20) and the lower case(40).

Preferably, a bracket assembly 70 including an upper bracket 73, a lower bracket 71 and a bolt 72 to connect the upper and lower brackets 73, 71 is installed in the upper case 10, to hang the LED lighting on a wall side or a support bar. The function and connection relationship of each component forming the LED lighting according to the embodiment of the present invention as shown in FIG. 6 are identical with those according to the embodiment of the present invention as shown in FIG. 3. The constitutional difference exists in the shape of the heat pipe module 20.

The LED lighting according to the present invention can be used for an ordinary indoor light, streetlight or any other diverse usage. The LED lighting may be manufactured by a plurality of the heat pipe modules 20 and a plurality of the LED modules 30 connected with the heat pipe modules 20.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements. Accordingly, it should be understood that there is no intent to limit the exemplified embodiments of the invention to the particular forms disclosed, but on the contrary, exemplified embodiments of the invention are to cover all modifications, equivalents, and alternatives falling within the scope of the invention.

1. An LED lighting comprising:
a heat pipe module (20) installed on the top of an LED module (30);
a lower case (40) positioned under the heat pipe module (20) and the LED module (30), to receive the heat pipe module (20) and the LED module (30); and
an upper case (10) connected with the lower case (40), to define an inner space to receive the heat pipe module (20) and the LED module (30),
wherein molding (50) is inserted between the upper case (10) and the lower case (40), to connect the upper case (10) and the lower case (40).

2. The LED lighting according to claim 1, wherein the heat pipe module (20) comprises:
a heat pipe holder (22) installed on the top of the LED module (30); and
a heat pipe (21) attached around the heat pipe holder (22).

3. The LED lighting according to claim 1, wherein the LED module (30) comprises:
a PCB (31) attached to the underside of the heat pipe module (20);
an LED device (301) evenly arranged on the PCB (31); and
a board cover (32) including an opening formed at its center, the board cover (32) attached to the underside of the PCB (31).

4. The LED lighting according to claim 2, wherein the heat pipe holder (22) has a plane shape of “+” or “−” and comprises an upper heat pipe holder (23) and a lower heat pipe holder (24), each end of the upper heat pipe holder (23) and each end of the lower heat pipe holder (24) being bent so that each end of the upper heat pipe holder (23) touches each corresponding end of the lower heat pipe holder (24).

5. The LED lighting according to claim 4, wherein the upper heat pipe holder (23) and the lower heal pipe holder (24) respectively include slots (221) formed with a predetermined width at the center areas on the top side of the upper heat pipe holder (23) and the center area on the underside of the lower heal pipe holder (24), and the heat pipe (21) is received in the slots (221).

6. The LED lighting according to claim 4, wherein the upper heat pipe holder (23) includes an insertion groove (231) formed at the each end thereof and the lower heal pipe holder (24) includes a projection (241) formed at the each end thereof, so that the each projection (241) is fitted into the each insertion groove (231), to connect the upper heat pipe holder (23) and the lower heal pipe holder (24).

7. The LED lighting according to claim 3, wherein spaces between top side of the heat pipe module (20) and the upper case(10), and between underside of the heat pipe module (20) and the lower case(40) are filled with al grease or metal solder

8. The LED lighting according to claim 1, wherein the lower case (40) further comprises: an opening (41) formed in the center of the lower case (40), to permit the light of the LED device (30) to shine to the outside; and a plurality of drain holes (42) formed at regular intervals, along with the edge of the lower case (40), to allow rainwater to flow out.

9. The LED lighting according to claim 1 comprising: a plurality of the heat pipe modules (20) and a plurality of the LED modules (30) installed in a case forming of the upper case (10) and the lower case (40).
